(19) United States
(12) Patent Application Publication
(10) Pub. No.: US 2003/0101128 A1
(43) Pub. Date: May 29, 2003

(54) State tracking system for a basket trading system

(76) Inventor: William Randolph Abernethy, Agua Dulce, CA (US)

Correspondence Address: STAAS & HALSEY LLP, 700 11TH STREET, NW, SUITE 500, WASHINGTON, DC, 20001, US

(21) Appl. No.: 09/995,712

(22) Filed: Nov. 29, 2001

(51) Int. Cl. G06F 17/60

(52) U.S. Cl. 705/37

(57) ABSTRACT

The present invention is a tracking system that includes an order tracking database that stores the status of orders as they are processed within a distributed order fulfillment system that has a number of order execution systems that fill all or part of each order. Each order goes through a number of different transaction stages and the result of each stage is reported as an event to the database. The events are transmitted as messages using an output queue in the order execution system and an event message queue in an event tracking service. The tracking service updates the database when events appear in the event queue. The message processing system operates independently of order processing allowing order processing to continue while the tracking service updates the database. The messages include the components of an asset record of a core system database. The status of any order within the distributed system can be obtained from the database. The system also includes execution confirmation and error tracking with corresponding centralization of this information.

### CROSS-REFERENCE TO RELATED APPLICATION(S)

This application is related to U.S. provisional patent application Serial No. 60/110,524, filed Dec. 1, 1998, entitled “METHOD AND APPARATUS FOR TRADING USER-DEFINABLE GROUPS OF FUNGIBLE GOODS SUCH AS SECURITIES,” by William Randolph Abernethy et al. (Atty. Dkt. 1497.1001-P); U.S. patent application Ser. No. 09/433,659, filed Nov. 3, 1999, entitled “METHOD AND SYSTEM FOR TRADING USER DEFINABLE BASKETS OF FUNGIBLE GOODS SUCH AS SECURITIES,” by William Randolph Abernethy et al. (Atty. Dkt. 1497.1001); U.S. patent application Ser. No. 09/672,838, filed Sep. 29, 2000, entitled “A BASKET TRADING SYSTEM HAVING AN INTERFACE FOR USER SPECIFICATION OF GOODS TO BE TRADED AS A UNIT,” by William Randolph Abernethy (Atty. Dkt. 1497.1002); U.S. patent application Ser. No. 09/675,583, filed Sep. 29, 2000, entitled “AN ELECTRONIC CROSSING SYSTEM FOR SECURITY BASKETS,” by William Randolph Abernethy (Atty. Dkt. 1497.1003); U.S. patent application Ser. No. 09/672,840, filed Sep. 29, 2000, entitled “A BASKET PRICE QUOTATION SYSTEM,” by William Randolph Abernethy (Atty. Dkt. 1497.1004); and U.S. patent application Ser. No. 09/672,839, filed Sep. 29, 2000, entitled “AN ORDER ROUTING SYSTEM FOR FUNGIBLE GOODS TRADES IN A BASKET TRADING SYSTEM,” by William Randolph Abernethy (Atty. Dkt. 1497.1005), all incorporated by reference herein.

### BACKGROUND OF THE INVENTION

1. Field of the Invention

The present invention is directed to a system that tracks events in a fungible goods trading system designed for trading fungible goods, such as stocks, and, more particularly, to a system that tracks events in a distributed basket trading system independently of order processing including trade progress events or order state events or reports, trade execution events, confirmations or reports and error events or reports.

2. Description of the Related Art

Today, order entry and fulfillment systems, such as a web site where an individual can order an item, such as a sweater, track orders by assigning an order number to the message and placing the order in a message queue. When the system is ready to process the order through to completion, the message is accessed in the queue, the message is processed, the database is updated to indicate that the order has been processed and the message is removed from the queue. As the orders mount in such a system, the messages back up in the queue until they are processed. As a result, orders may not be filled for some period after they are placed. Tracking orders in such a system is also very simple.

As systems become more complex and the need for real-time order processing increases, such as occurs in basket trading systems, one solution to fulfilling the orders in real-time is to divide the system into parts and distribute the functions being performed over many computers. That is, create a real-time, distributed order system. However, as the functions become more distributed, tracking the progress of orders within the system becomes more difficult. What is needed, is a system that will track orders in a distributed, real-time order fulfillment system.

Errors that occur in such a distributed system occur in the various machines and distributed processes. Errors within such a system also need to be tracked as events and as errors.

Trade execution reports in a distributed trading system also occur or are produced by the distributed system and these trade execution reports also need to be tracked as events and as confirmations.

### SUMMARY OF THE INVENTION

It is an aspect of the present invention to provide a centralized tracking system including a centralized basket order tracking database for orders being processed in a distributed, real-time, order fulfillment system.

It is another aspect of the present invention to provide a person viewing the orders within a distributed, real-time, order fulfillment system with a single consolidated view of all the orders within the system even though the order status information is being contributed from many places within the system.

It is also an aspect of the present invention to provide a centralized tracking system for errors occurring in a distributed, real-time, fungible goods order fulfillment system.

It is an additional aspect of the present invention to provide a centralized tracking system for trade execution reports or confirmations produced in a distributed, real-time, fungible goods order fulfillment system.

The above aspects can be attained by a system that includes an order tracking database that stores the status of orders as they are processed within a distributed system having a number of order execution systems where each order execution system fills all or part of each order. Each order goes through a number of different stages and the result of each stage, event or micro-event is reported as an event to the database. The events are transmitted as messages using input and output message queues via a message processing system that operates independently of order processing, allowing order processing to continue while event tracking messages asynchronously update the event tracking database. The status of any order within the distributed system can be obtained from the event tracking database over a communication network, such as the Internet, using a web based graphical user interface. Similarly, the system includes an error report trading database containing error events and an execution trade report database containing execution events or confirmations which receive messages via the message processing system and which error and execution events can be tracked using the interface.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 depicts the components of the present invention.

FIG. 2 illustrates the queues and operations of the present invention.

FIG. 3 depicts the structure of the tracking database.

FIG. 4 depicts the structure of an asset order record.

FIG. 5 depicts the structure of an execution event record.

FIG. 6 is an example of a GUI used to request an event report.

FIGS. 7A and 7B provide an example of an event report, particularly an order event report.

FIG. 8 depicts the tracking system of the present invention.

### DETAILED DESCRIPTION OF THE PREFERRED EMBODIMENTS

The present invention is designed to provide a user, such as a customer service representative, a single view of the orders in a distributed, real-time, order fulfillment system where the orders are composed of one or more fungible goods, such as stocks. In a typical situation, an order for a trade arrives over a communication network, such as the Internet. The order is processed by a core trade processing system that updates a core trade database and sends the order (or part of the order as required) to one or more order execution systems in a distributed order execution system. When the order is filled, the core system is informed and the core database is updated. During processing of the order, a user may want to find out the status of the order.

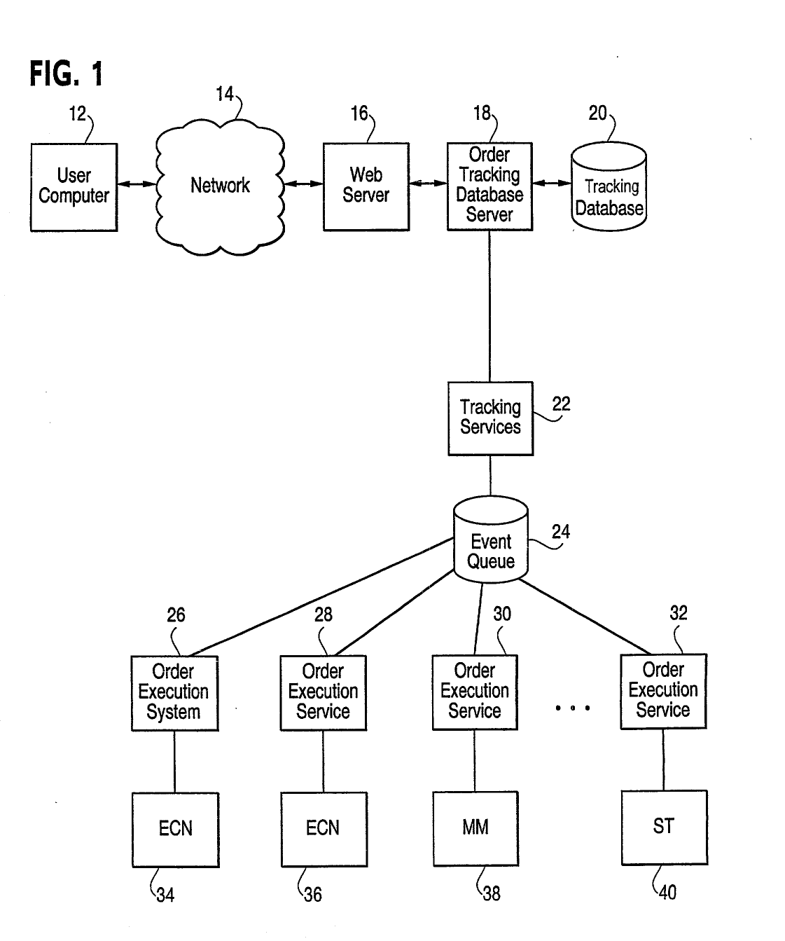

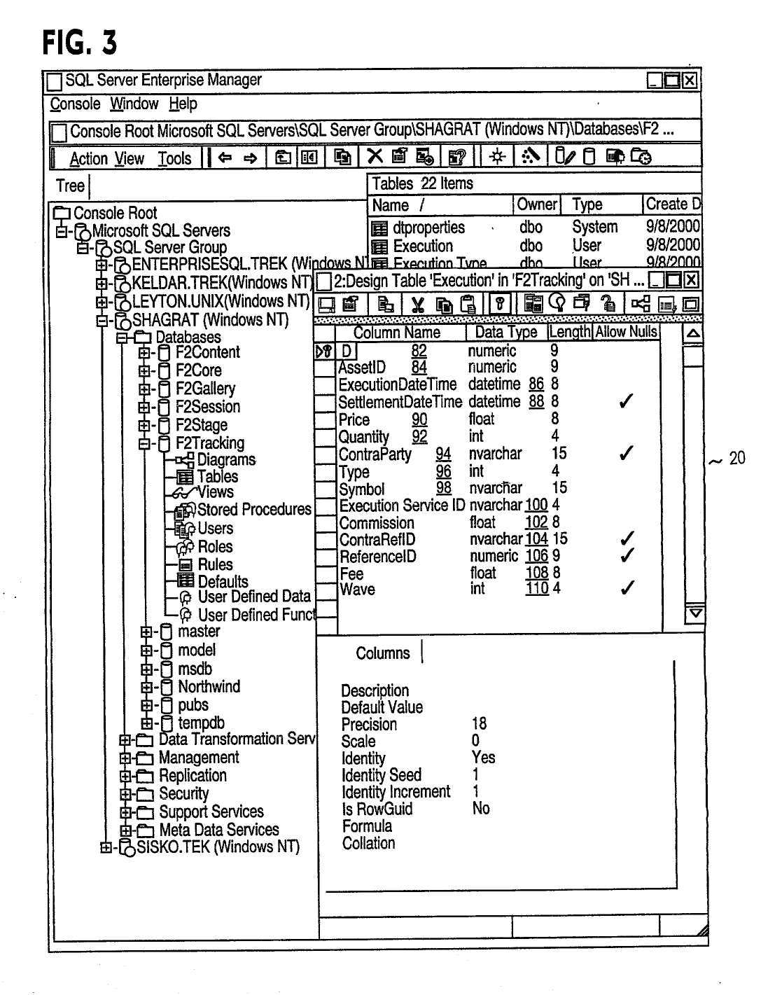

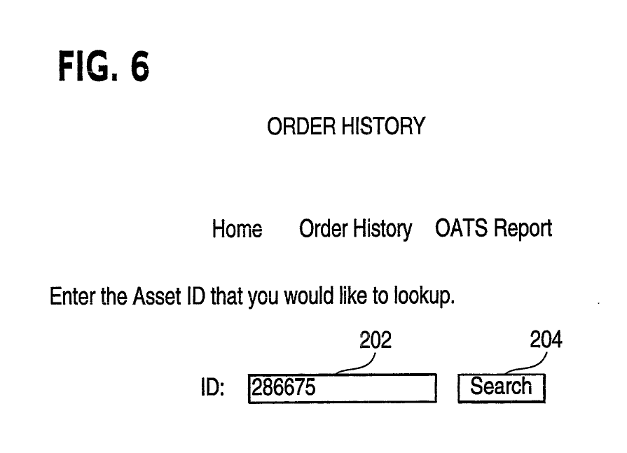

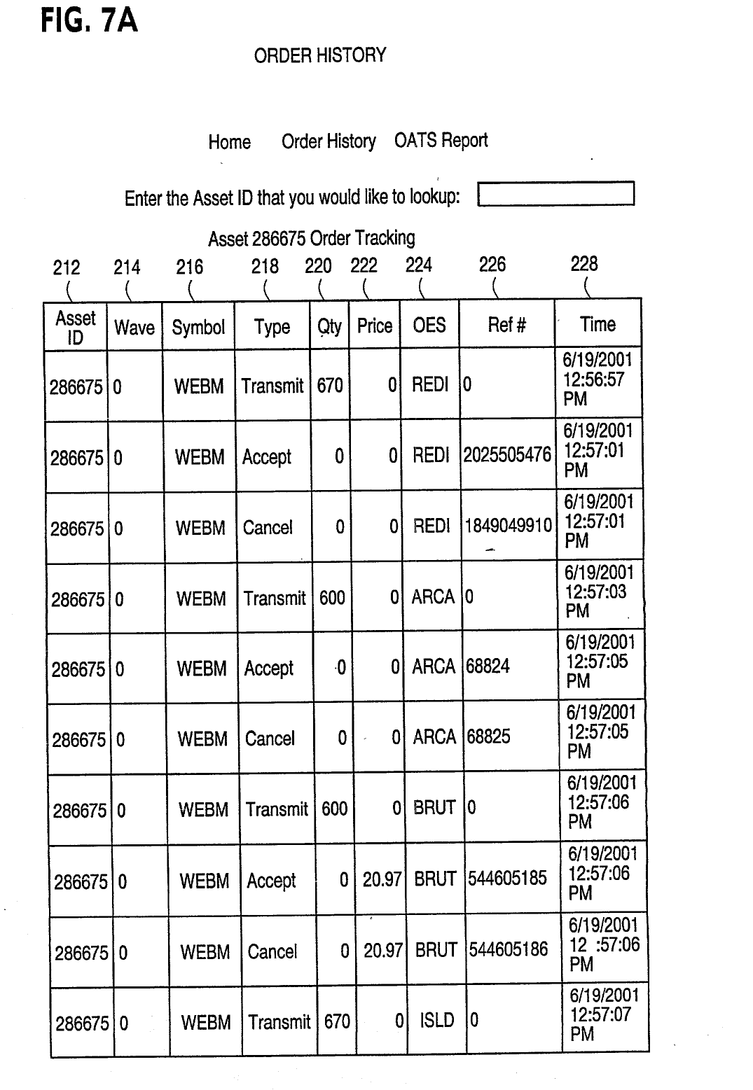

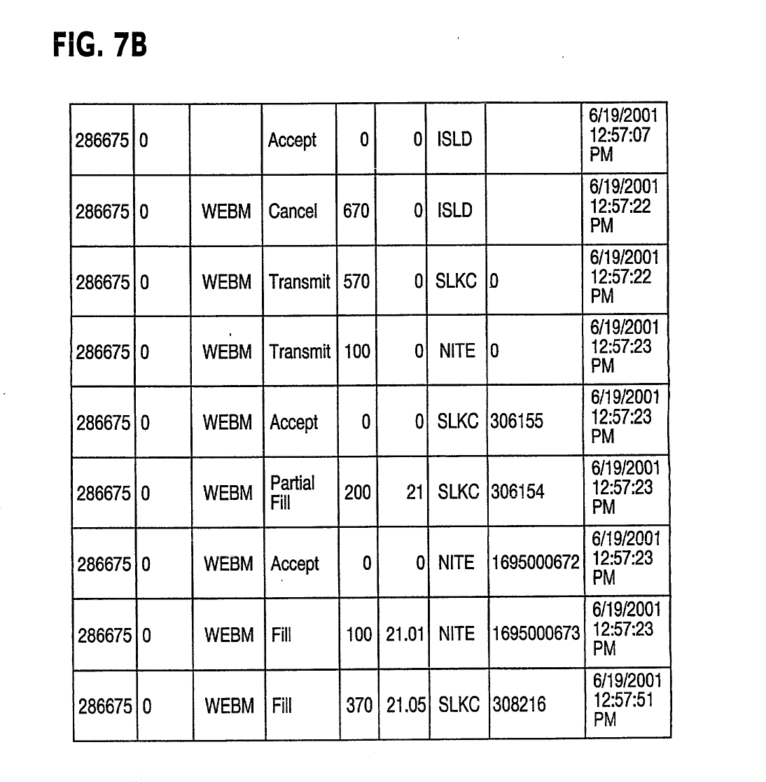

In a situation where the user desires to know the status of the order, as depicted in FIG. 1, the user, via a conventional browser located on the users computer 12, makes a request (see the GUI of FIG. 6) to view the status of one or more orders in a basket trading system, such as that provided by UNX, Inc. of Burbank, Calif. The request is transmitted over a network 14, such as the Internet or an internal network of the trading system, to a web server (service) 16. The web server 16, which performs presentation operations as requested by users, processes the request and makes a query to an order-tracking database server (service) 18 for the status of the identified order(s). The tracking server 18 accesses a centralized tracking database 20 (see FIG. 3) to obtain the needed information and responds to the web server 16 with the status information. The tracking database 20 stores status information about all of the orders, pending as well as completed and historical, in the system. The web server 16 composes and sends a web page to the user's computer 12 showing the status information or event report requested and the status information is presented to the user by the web browser (see FIGS. 7A and 7B).

The database 20 of the tracking server 18 is updated by a tracking service (server) or engine 22 which accesses an event queue 24 that stores event information about events that have occurred during order processing. The tracking service 22 is an event driven, asynchronous, service that awakens and processes event messages as they are received in the queue 24. When an event message exists in the event queue, the tracking service 22 awakens, retrieves the event message from the (top of the) queue 24, determines the type of event, and what information within the tracking database needs to be updated. The service 22 then sends an update to, or performs an update or insert transaction, with the database server 18 where the database 18 is updated. Transaction processing is a handshaking process that confirms storage in the destination (queue or database) before the message is removed from the sending queue and one which uses globally unique identifiers that include the sending machine address and the date/time for the message to avoid message duplication when a failure occurs. Failure during a transaction results in the sending queue being restored to the queue state as that state existed before the failure.

The event queue 24 is a centralized queue that asynchronously receives event messages or order events from a number of distributed order execution (servers) services (OESs) 26, 28, 30 and 32 of a distributed architecture system, such as that described in the routing system application previously mentioned and implemented in the UNX system accessible at http://www.unx.com/. Each of the execution services 26, 28, 30 and 32 sends orders for stocks of the stock baskets to a single vendor or single order completion system assigned to that OES over a communication network (not shown). For example, system 26 sends orders only to a first electronic stock trading system (ECN) 34, system 28 sends orders only to a second ECN 36, system 30 sends orders only to a market maker (MM) processing system 38, and system 32 sends orders only to a specialist trading (ST) system 40. A smart order router (not shown) reviews an order and determines whether a part or all of the order is sent to one or more of the OESs. As the orders are executed by one of the order completion systems, the corresponding execution system receives completion messages and produces event messages for the queue 24. For example, if a sell order is sent by system 30 to market maker 38 for 100 shares of IBM, when the market maker buys the shares, a “fill” message is sent to the system 30, which then sends an event message to the queue 24 indicating that 100 shares have been sold to market maker 38. The message also indicates the price and other information. The event message results in the database being updated so that the user can see the completed status of the order to sell the 100 shares of IBM.

The tracking system can be protected from failure using a failover cluster. The primary node of the cluster hosts the event tracking queue and database through a shared disk subsystem. Should an element (hardware/software) on the primary node fail, the back up node will take control of the shared disk subsystem and restore operation. Another redundancy approach is to run two tracking systems in parallel having all message sources (such as OESs) send events to both systems.

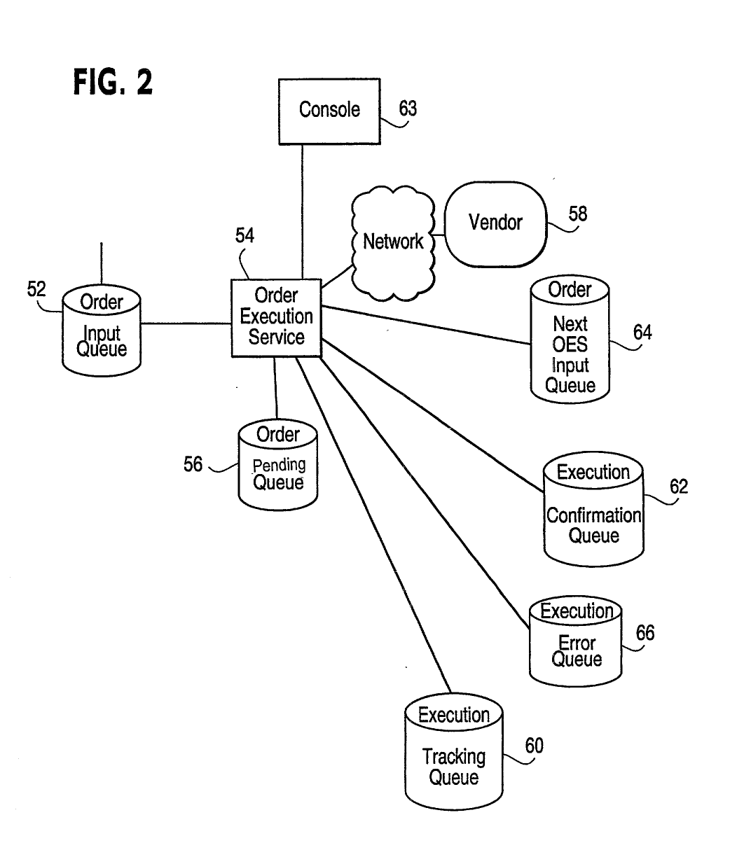

Initially, a public input queue 52 of an OES 54 (see FIG. 2) is empty. An order arrives in the queue 52 from, for example an order router (not shown), another service, etc. and the OES 54, is awakened from a wait state on an input queue processing handle. The order is processed, such as by translating the order into a message in the protocol used to communicate with the OES, etc. and the order is then transmitted through a network to a vendor 58, such as a market maker 38. The order includes a unique order identifier (ID). The order is then placed into a private pending queue 56 and removed from the input queue 52. An event message indicating that the order has been sent to the vendor is then sent to the tracking event queue 60 (24). This ends transaction processing for the input queue item. (If a failure occurs after the order is sent to the vendor, the protocol for the vendor controls how a determination is made as to whether the vendor has responsibility for the order.) The order service is then released from responsibility for the order until some message arrives about this order, such as a message from the vendor indicating the order has been filled, and the service can process other orders in the input queue 52. As other orders asynchronously arrive they are also sent to the vendor, moved to the pending queue, etc.

The event message going to the tracking queue 60 is actually placed in an out-going or output message queue (not shown) typically on the same machine and the execution service is released from responsibility for the event tracking message once the output message queue is updated and the service can then process more orders. A separate message process/service within the server 54 examines the output message queue, and performs the transaction processing required to send the message to the event-tracking queue 60. Message handling is preferably performed during idle order processing time if the server has only one processor/CPU. If the server 54 contains more than one processor, one or more of the processors process orders while one of the processors processes or handles sending event messages to the tracking service 18. Message handling for tracking events, including order state events, execution tracking events, error tracking events, etc., takes a lower priority for processor time than order processing.

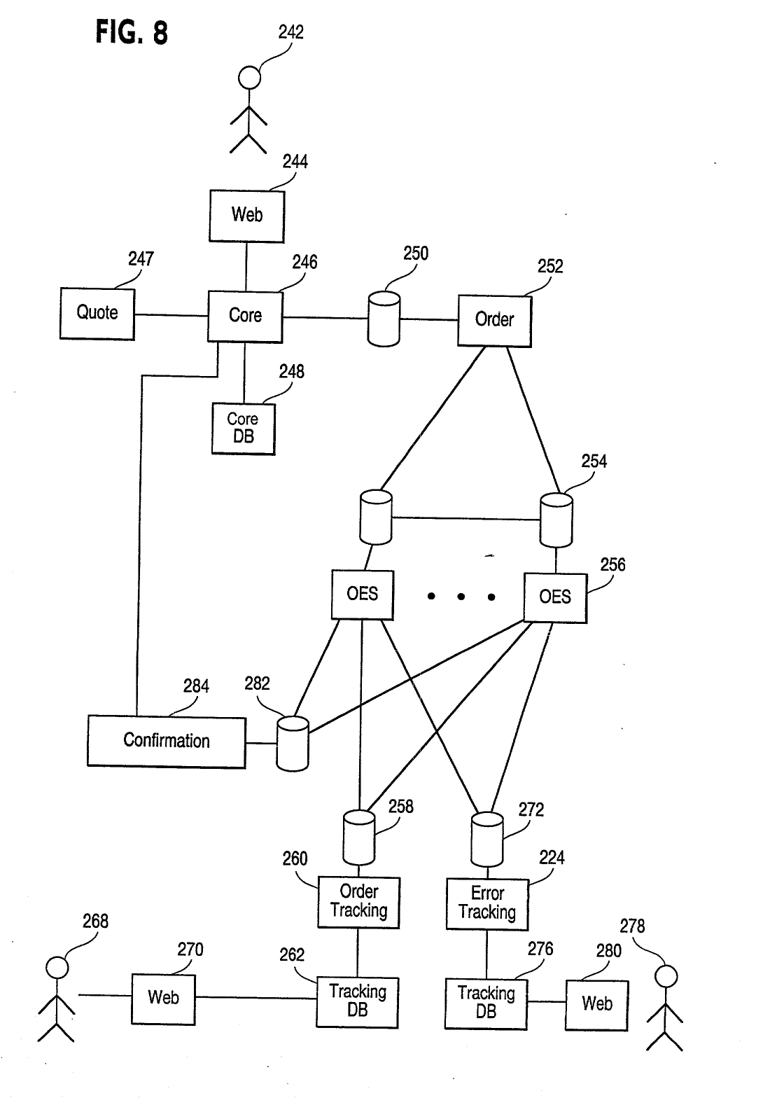

The vendor 58 can completely or partially fill the order, for example, the order may be for 100 shares at a specific price and the vendor could only supply 50 shares at that price. In this example, we will assume that the order is partially filled. When the OES 54 receives an asynchronous “partial” execution message having the unique order ID over the communications network from the vendor 58, the OES 54 awakes on an execution processing handle, the order is removed from the pending queue 56, the order is updated and the order is returned to the pending queue 56. In this situation a core database (see FIG. 8), that stores information for the fulfillment system, receives an update via a confirmation message in correspondence to the event reported to the event service. An execution event is also reported to the tracking system by sending a trade execution event (or report) to the tracking queue 60. This event indicates the status of the execution, such as fill, partial fill, cancel, order transmit, reject, correction, etc. and in this case it would indicate a partial fill. This execution (partial fill) is also reported to a confirmation service (not shown) by sending a message via transaction processing to the confirmation queue 62. This ends the transaction processing for the partial fill message. The updated order remains in the pending queue 56 until it is cancelled or completed (in which case a “fill” message is received from the vendor).

The confirmation service retrieves the confirmation message from the confirmation queue 62 and sends a confirmation to the core which records or updates the partial fill of the order in the core database. This happens independently of order processing and event processing. When the final order message arrives, an e-mail service sends a confirmation to the trader via SMTP or some other message protocol.

At any time the most recent record in the event database for the order indicates the current or very recent state of the order. The same applies to errors and confirmations.

The pending order can be cancelled in a number of different ways. The receipt of a message from the vendor 58 that the order could not be filled or completed, if partially completed, can cancel the order. The order can be cancelled by a cancel order originating from the trader who placed the order. The order can also be cancelled by a cancel request sent from the smart order router if the order is not filled within a certain period. The order can also be cancelled because it's effective time period lapses. When the OES 54 receives an asynchronous cancel/quit order, such as from a network socket coupled to a control console 63, the OES 54 awakes, removes the order from the pending queue 56, and reports the cancellation to the tracking system by sending a message via transaction processing to the tracking queue 60.

Order execution services can be broken down into a number of types. One type is a dead end service, which will always result in the filling of an order or the failure of the order (i.e. it cannot be filled). An OES interacting with a market maker may be such a service. Another type of OES is an open-ended service that may not result in the filling of an order. An OES interacting with an ECN is typically such a service. Orders sent to open ended services have time-outs associated with them. If a cancel order is received by an open-ended service because the time-out has expired, the pending order is removed from the pending queue 56 and sent to the input queue 64 of another service that can complete the order.

Any errors that occur during order processing, in addition to being reported to the tracking system 22, are also reported via transaction processing to a centralized error tracking system by sending an error message to the error queue 66. Error message processing also happens independently of order processing.

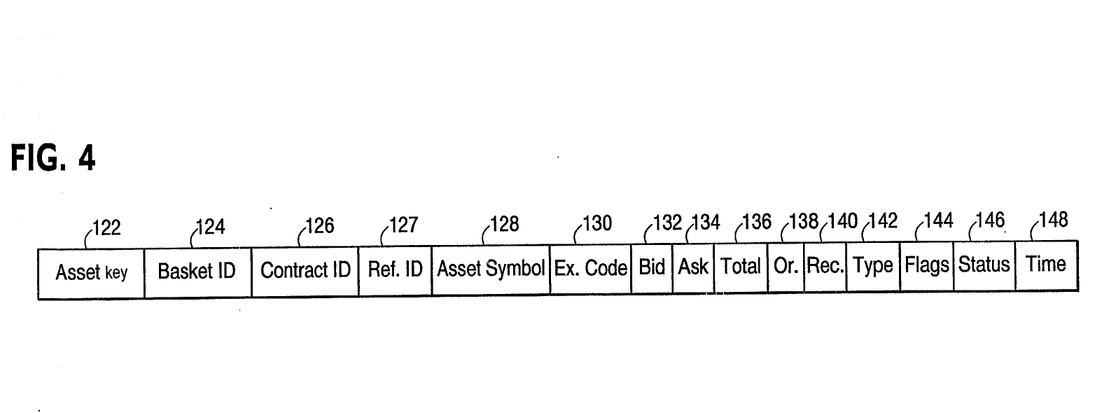

The tracking database 20, as illustrated in FIG. 3, includes fields for the master record ID 82 and the asset record ID 84 which is a link to the asset order record (see FIG. 4) where information about the order, such as, how much has been filled, etc. is stored. Execution 86 and settlement 88 dates and times are provided in this database 20. The price 90 and quantity 92 of the order along with the contra party 94 on the other side of the order, a type 96 of event and the asset symbol 98, such as the stock ticker symbol, are also stored. The database 20 also stores the identifier 100 of the vendor, a commission 102, a reference ID 104 for the contra party, a reference ID 106 including the execution number, a transaction fee 108 and a wave 110 of the order. This information can be provided in a report as depicted in FIG. 7.

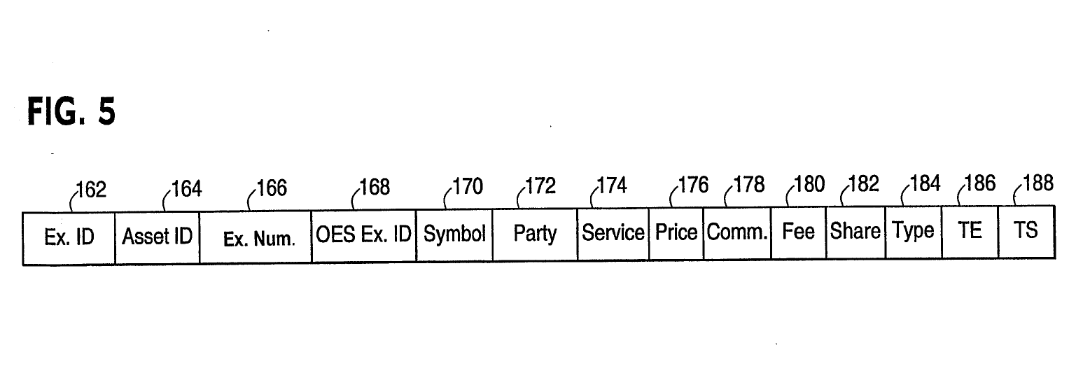

The asset record or asset order record (see FIG. 4), which is being moved around in the OES and order message queues, such as the input queue, pending queue, etc. preferably stores: a primary asset key 122 (8 bytes), a basket ID 124 of the basket to which the asset belongs (8 bytes), a contact ID 126 of the contact (trader) for the order (8 bytes), a reference ID 127 for the asset which contains a target account of the asset for unexecuted orders and points to related assets for executed assets (8 bytes), an asset exchange symbol 128 (32 bytes), an exchange code 130 for the exchange, such as NASDAQ, on which the asset is traded (8 bytes), bid 132 and ask 134 prices at the time of the order (8 bytes each), a total cost 136 of the asset at the time of the trade (8 bytes), the quantities ordered 138 and received 140 (4 bytes each), a type 142 of order ( market, limit, on close, etc. −4 bytes), flags 144 for the order that indicate information about the order such as whether it is good for only one day (4 bytes), asset status 146 (filled, accepted, filling, submitted, etc. −4 bytes) and a time 148 that the order for the asset was entered into the trading system (16 bytes). The structure of this record is well aligned (divisible on 8, 24, 32 and 64 byte boundaries) allowing it to be easily transferred through OS kernel operations and over networks and to be read from various types of memory. It also matches the structure of the core database of the trading system where asset records of accounts are stored allowing storage into that database without content mapping. The order event record (see FIG. 5), which is being moved around in the event messages of the order report tracking service, such as in the tracking queue, the confirmation queue, error queue, etc. preferably stores: a primary execution key 162 (8 bytes), an asset ID or order number 164 (8 bytes), an execution number 166 (8 bytes), an OES execution ID 168 (32 bytes), the asset exchange symbol 170 (32 bytes), trading party ID/name 172 (32 bytes), service 174 executing the order (16 bytes), execution price 176 (8 bytes), commission 178 (8 bytes), SEC fee 180 for sell orders (8 bytes), quantity 182 or share count executed (4 bytes), a type 184 of event (partial, fill, cancel, reject, etc. −4 bytes), an execution time 186 (16 bytes), and a settlement time 188 that the order for the asset will settle (16 bytes). The structure of this record is also well aligned (divisible on 8, 24, 32 and 64 byte boundaries) allowing it to be easily transferred through OS kernel operations and over networks and to be read from various types of memory. It also matches the structure of the core database of the trading system where asset records of accounts are stored allowing storage into that database without content mapping.

Some regulatory agencies require trade systems and brokers to report order routing events. The system described herein supplies an effective centralized source for all trade routing data and is specifically compliant with the needs of the NASD's Order Audit Trail System (OATS).

The user requesting tracking information at the users computer 12 preferably uses a graphical user interface (GUI), such as depicted in FIG. 6, which has a field 202 for entering an identifier of an asset order and a button, 204 for starting a search. The GUI report on an event tracking request, as depicted in FIGS. 7A and 7B, preferably has fields for: asset ID 212, a wave number 214 of the order, an asset symbol 216 which is the stock symbol for stocks, a type 218 of the event, a quantity 220 of the asset, the price 222 obtained, the vendor 224 associated with the OES of the trading system, a reference number 226 and a time 228 of the event. This particular order event report shows the micro events of an order for 670 shares of WebMethods, Inc. stock being sent to five vendors before it is broken into two orders which are filled by two different vendors in just less than one minute where one of the vendors partially filled the order to it before completing the filling of the order to it. In this report, the “Transmit”, “Accept” and “Cancel” entries are order events while the “Partial Fill” and “Fill” entries are confirmation events as well as order events.

In a distributed system for which the present invention is designed, a stock order placed by a trader 242 over the web 244 is received by a core trading system 246 (see FIG. 8). If needed, the core trading system obtains a quotation for the stock from a quote system. The order or order message (see FIG. 4) is used to update the core database 248 and is placed in a queue 250 of an order routing system 252. The routing system 252 routes the order (see FIG. 4) to a queue 254 of one or more order execution systems 256. As the order progresses, order tracking events or messages (see FIG. 5) are placed in a queue 258 of a order tracking system 260 and used to update an order tracking database 262 (see FIG. 3). A customer service representative 268 can obtain an order tracking report for the order from the database over the web 270. If an error occurs during order processing, an error event is placed in a queue 272 of an error tracking system 274 (as well as in the queue 258 of the tracking system 260) and used to update an error-tracking database that is accessible by a system technician 278 over the web 280. As orders get filled, confirmation events (see FIG. 5) are placed in a queue 282 of a confirmation tracking system 284 (as well as in the queue 258 of the tracking system 260) and used to update the core database 284 through the core processing system 246. When an order is completed, a confirmation process is alerted and a confirmation message (via e-mail or some other messaging system) is sent to the trader 242. Transactional queuing systems, such as MQ Series/IBM and MSMQ/Microsoft, provide high levels of transactional messaging reliability. Specifically these systems ensure that a single copy (not two not zero) arrives at the destination queue. Commercial systems such as these typically supply the substrate of a system such as that described herein.

The system of the present invention also includes permanent or removable storage, such as magnetic and optical discs, RAM, ROM, etc. on which the process and data structures of the present invention can be stored and distributed. The processes can also be distributed via, for example, downloading over a network, such as the Internet.

The present invention has been described with respect to the components being distributed such as depicted in FIG. 1. However, it is possible for the processes to be more or less distributed than in FIG. 1. It is also possible for the order, error and execution tracking systems to be implemented as a single combined tracking system for tracking all events within the distributed order fulfillment system. If the order fulfillment system discussed herein is not a distributed system, that is, when the order fulfillment system is a single monolithic system, the present invention (in a single tracking server) can be used to offload the processing of user, customers service representative and technician inquiries about order states, executions and errors.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A system, comprising:
a distributed order fulfillment system having two or more order execution services performing order processing for stock orders and producing confirmations of executions in the order processing; and
a tracking system having a centralized tracking database storing the confirmations regarding the orders, with the tracking system operating asynchronously and independently with respect to the order execution, the tracking system comprising:
a confirmation queue receiving the confirmations comprising an asset order identifier and a confirmation type; and
a tracking service processing the confirmation messages and updating the database; and
an interface system accessing the database to produce confirmation reports responsive to user requests.

2. A system, comprising:
a distributed order fulfillment system having two or more order execution services performing order processing for orders and producing tracking information for operations of the order processing; and
a tracking system having a tracking database storing the tracking information regarding the operations.

3. A system as recited in claim 2, wherein the tracking database is centralized and stores tracking information for all of the order execution services.

4. A system as recited in claim 2, wherein the tracking information comprises order processing event messages and the tracking system comprises:
an event queue receiving the event messages;
a tracking service processing the event messages; and
a tracking database storing order event information.

5. A system as recited in claim 4, further comprising a message processing system transmitting the event messages between the order execution services and the event queue.

6. A system as recited in claim 2, wherein the events comprise order events, confirmation events and error events with corresponding event messages.

7. A system as recited in claim 6, wherein execution messages comprise an asset order identifier and an event type.

8. A system as recited in claim 7, wherein the execution messages further comprise execution number, asset symbol, trading party, execution service identifier, execution price, commission, fee, execution time and settlement time.

9. A system as recited in claim 2, wherein tracking information comprises an asset order identifier and an event type.

10. A system as recited in claim 9, wherein the tracking information comprises a primary event key, an execution date, a settlement date, an asset price, an asset quantity, a contra party, an asset symbol, an execution service identifier, an order commission, a contra party reference identifier, an execution reference, an order fee and an order wave.

11. A system as recited in claim 2, wherein the tracking system further comprises an input access system allowing a user to access the tracking information.

12. A system as recited in claim 11, wherein the input access system comprises:
a tracking database storing the tracking information; and
a web server accessing the tracking information for a web browser tracking information request.

13. A system as recited in claim 2, wherein the tracking system operates independently of the order execution services.

14. A system as recited in claim 2, wherein order processing has a higher priority for processor time than tracking processing.

15. A system as recited in claim 2, wherein order processing and tracking event processing comprise transaction operations.

16. A system as recited in claim 2, wherein the orders comprise orders for stock.

17. A system, comprising:
a distributed order fulfillment system having two or more order execution services performing order processing for stock orders and producing order tracking information for operations of the order processing;
a tracking system having a centralized tracking database storing the tracking information regarding the orders, the tracking information comprising order, execution and error tracking information with the tracking system operating asynchronously and independently with respect to the order execution services and order processing having a higher priority for processor time than tracking processing, the tracking system comprising:
an event queue receiving tracking information event messages comprising an asset order identifier and an event type; and
a tracking service processing the event messages and updating the database; and
an interface system accessing the database to produce tracking reports responsive to user requests.

18. A process, comprising:
producing events messages for stock order processing events occurring in a distributed stock order processing system; and
storing the events in a centralized storage.

19. A process as recited in claim 18, wherein event processing is performed independently and with a lower priority than order processing.

20. A computer readable storage controlling a computer by producing event messages for stock order processing events occurring in a distributed stock order processing system and storing the events in a centralized storage.

21. A computer readable event tracking data structure controlling a computer having fields for an asset identifier and an event type.

22. A system, comprising:
a distributed order fulfillment system having two or more order execution services performing order processing for orders and producing order confirmation information for operations of the order processing; and
a tracking system having a centralized confirmation-tracking database storing the confirmation information regarding the orders.

23. A graphical user interface for stock share order event tracking comprising fields for an asset identifier and an event type.

24. A graphical user interface as recited in claim 23, further comprising fields for a wave number, a stock symbol, a share quantity, a price, a vendor, a vendor reference and an event time.

25. A method, comprising:
tracking stock order states in a distributed stock order fulfillment system; and
storing the states in a centralized database.

26. A method as recited in claim 25, wherein the states comprise one of an order event, a confirmation event and an error event.
